(19) United States
(12) Patent Application Publication
(10) Pub. No.: US 2024/0086763 A1
(43) Pub. Date: Mar. 14, 2024

(54) ADAPTIVE SAMPLING TO COMPUTE GLOBAL FEATURE EXPLANATIONS WITH SHAPLEY VALUES

(71) Applicant: Oracle International Corporation, Redwood Shores, CA (US)

(72) Inventors: Jeremy Plassmann, Annecy-le-Vieux (FR); Anatoly Yakovlev, Hayward, CA (US); Sandeep R. Agrawal, San Jose, CA (US); Ali Moharrer, Belmont, CA (US); Sanjay Jinturkar, Santa Clara, CA (US); Nipun Agarwal, Saratoga, CA (US)

(21) Appl. No.: 17/944,949

(22) Filed: Sep. 14, 2022

(51) Int. Cl. G06N 20/00; G06N 5/04

(52) U.S. Cl. CPC G06N 20/00; G06N 5/042

(57) ABSTRACT

Techniques for computing global feature explanations using adaptive sampling are provided. In one technique, first and second samples from an dataset are identified. A first set of feature importance values (FIVs) is generated based on the first sample and a machine-learned model. A second set of FIVs is generated based on the second sample and the model. If a result of a comparison between the first and second FIV sets does not satisfy criteria, then: (i) an aggregated set is generated based on the last two FIV sets; (ii) a new sample that is double the size of a previous sample is identified from the dataset; (iii) a current FIV set is generated based on the new sample and the model; (iv) determine whether a result of a comparison between the current and aggregated FIV sets satisfies criteria; repeating (i)-(iv) until the result of the last comparison satisfies the criteria.

### TECHNICAL FIELD

The present disclosure relates to machine learning and, more particularly, to generating global explanations of a machine-learned model using an adaptive sampling technique.

### BACKGROUND

Machine learning (ML) is a type of artificial intelligence (AI) that allows software applications to become more accurate at predicting outcomes without being explicitly, programmed to do so. ML algorithms use historical data as input to predict new output values. However, as ML models have become more sophisticated and complex, they have become more difficult to explain. The “explainability” of a ML model refers to the ability to identify which features of the ML model are the most important and their relative importance to each other. In other words, if it is possible to identify features that have the most impact on the output of an ML model, then the ML model is explainable.

Shapley values are the current state-of-the-art in terms of explainable machine learning. The idea comes from game theory in which the Shapley value represents the contribution in the final score of a game of a player or a group of players in a coalition. To compute these values, every possible coalition must be sampled to evaluate the impact of a player when that player is part of the coalition and when that player is not. The average of all the differences of scores is the Shapley value associated to that player.

Data scientists have translated that theory for explainable machine learning. A ML model is considered the game, the outcome of the game is considered the score, and the features of the ML model are considered the players. With that configuration, it is possible to compute the Shapley values associated with the features. The Shapley values show the contribution of each feature in the prediction of the ML model. However, there are a lot of permutations (coalitions) to be evaluated; the size of the set of permutations is O(2\hat{ }n) where n is the number of features.

This inefficient computation drove researchers to create an approximation method, referred to as SHAP (“SHapley Additive exPlanations”). This method is based on sampling coalitions from the set of all the coalitions and then evaluating the sampled coalitions with the model. A linear regression is performed between the coalition and the values of the model. The parameters that are the solution to the linear regression are the Shapley values.

Even with the SHAP method, in order to compute a global feature importance, a large set of local explanations have to be evaluated. The absolute value of these Shapley values is taken and then averaged over the entire dataset. This can take a long time for large datasets.

One approach to reduce the time to compute Shapley values is to randomly sample a fixed number of samples from a dataset and then parallelize the computation of local explanations. An average of the local explanations from the different samples is then computed. However, this approach does not provide any guarantees of the quality of the final explanation since the sampled dataset may be insufficient to properly explain the model. In other scenarios, the sampled dataset may be excessive in the number of samples, requiring excess computation time without improving explanation quality compared to a smaller sample.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of an example system for generating feature importance values based on a dataset, in an embodiment;

FIG. 2 is a flow diagram that depicts an example process for performing adaptive sampling, in an embodiment;

FIG. 3 is a chart that depicts a measure of performance of an adaptive sampling technique relative to a non-adaptive sampling technique, in an embodiment;

FIG. 4 is a chart that depicts a different measure of performance of an adaptive sampling technique relative to a non-sampling technique, in an embodiment;

FIG. 5 is a block diagram that illustrates an example computer system upon which an embodiment of the invention may be implemented;

FIG. 6 is a block diagram of a basic software system that may be employed for controlling the operation of the example computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for adaptively sampling to compute global feature explanations with Shapley values. In one technique, a relatively small subset of a dataset is sampled. First local explanations are computed based on rows in the sampled subset (one local explanation for each row in the sampled subset) and a global explanation is computed based on aggregating the first local explanations, resulting in a first vector (e.g., of Shapley values). Then, a second subset of the same size is sampled from the dataset, second local explanations are computed based on the rows in the second subset, and a global explanation is computed based on aggregating the second local explanations, resulting in a second vector. The global explanation may also be based on the first local explanations (that were used to generate the first vector). The two global explanations are then compared by taking the norm of the difference of these two vectors and divided by the norm of the first vector. The result of this computation is referred to as “iterative error.” If the iterative error is below a specific threshold, then the process stops and the second vector (e.g., of Shapley values) is used as the final global feature explanation. Otherwise, the process returns to sampling a third subset that is double the size of the previously sampled subset. A new global explanation is computed on that third subset and a comparison is performed between the resulting third vector and a combination of the first two vectors. This process repeats until the updated iterative error is below the specific threshold.

Embodiments improve computer-related technology. Specifically, embodiments generate feature importance values much faster than prior approaches without sacrificing quality of those values. For example, one or more orders of magnitude in latency reduction is achieved on relatively large datasets.

### System Overview

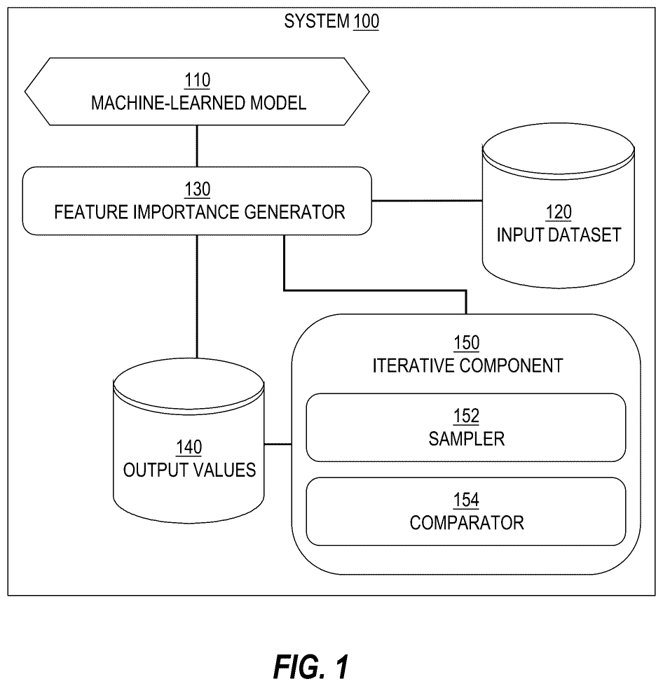

FIG. 1 is a block diagram of an example system 100 for generating feature importance values based on a dataset, in an embodiment. System 100 includes a ML model 110, an input dataset 120, a feature importance generator 130, output values 140, and iterative component 150. Each of feature importance generator 130 and iterative component 150 may be implemented in software, hardware, or any combination of software and hardware. Feature importance generator 130 and iterative component 150 may be implemented on a single computing device or different computing devices that are communicatively coupled to each other.

ML model 110 may have been trained using one of multiple machine learning techniques. Embodiments are not limited to the type of ML model 110. Examples of machine learning techniques include logistic regression, Decision Trees, Random Forest, Support Vector Machines (SVMs). Although only a single ML model 110 is depicted, system 100 may include multiple ML models.

Input dataset 120 is a set of input data items, each input data item being able to be input to ML model 110, which produces a single output or prediction. An input data item may comprise multiple values of different types. Example data types include integer, floating point, character array, String, Boolean, Date, bit arrays, and a ML embedding.

Input dataset 120 may have been the training dataset upon which ML model 110 was trained. Thus, input dataset 120 may include multiple (or all) training samples from that training dataset. While only a single input dataset 120 is depicted, system 100 may include multiple input datasets, one for each ML model that system 100 includes.

### Feature Importance Generator

Feature importance generator 130 generates, as output, a set of feature importance values for a feature set based on a portion of input dataset 120 and ML model 110. Each set of feature importance values is stored in output values 140. Output values 140 may be stored in a volatile storage (e.g., random access memory) or non-volatile storage, such as a disk or SSD. Each set of feature importance values may be stored as a vector. Each set of feature importance values is associated with a model identifier (ID) or a feature set (ID) that is associated with the ML model from which the set of feature importance values were generated. For example, if system 100 includes multiple ML models and multiple input datasets, then feature importance generator 130 generates a set of feature importance values for each ML model.

Feature importance generator 130 may implement one of multiple techniques to generate a set of feature importance values for a feature set of an ML model. Example techniques includes the original Shapley technique (which is O(2ⁿ)), SHAP, and Kernel SHAP, which is a model agnostic method to approximate SHAP values using ideas from LIME and Shapley values. Local Interpretable Model-agnostic Explanations (LIME) is a technique of explaining the predictions of a black box machine learning model by building a number of interpretable local surrogate models.

### Iterative Component

Iterative component 150 is the component of system 100 that significantly speeds up feature importance value generations by iteratively sampling input dataset 120 and evaluating the quality of feature importance values of growing sample sizes using an iterative error metric. Iterative component 150 allows for orders of magnitude speed-up on larger datasets without sacrificing the quality of the feature importance values.

In the depicted example, iterative component 150 includes sampler 152 and comparator 154. Iterative component 150 allows for the exponential growth of each sampled subset that is being evaluated in order to compute feature importance values. Thus, for example, initially, iterative component 150 invokes sampler 152, passing a sample size that is relatively small. Sampler 152 retrieves, from input dataset 120, a sample that is the size of the input sample size. Iterative component 150 invokes feature importance generator 130, passing the sample (or a reference to the sample), which computes a first set of feature importance values. Each set of feature importance values is referred to as (1) a “local explanation” of ML model 110 relative to the entire input dataset 120 or (2) a “global explanation” of ML model 110 relative to the portion of input dataset 120 upon which the set of feature importance values is based.

For example, for a first sample of rows 1-100, one hundred first local explanations are generated, one for each row. The one hundred first local explanations are aggregated to generate a first global explanation vector. Prior to, concurrently with, or subsequent to generating the first global explanation vector, one hundred second local explanations are generated for a second sample of rows 101-200, one for each row in that row set. In order to generate a second global explanation vector, these second local explanations are aggregated with the first local explanations. In other words, the second global explanation vector is a superset of local explanations of rows 1-200. Aggregating many local explanations is fast, but computing each local explanations takes a significant amount of time.

At the first iteration, the above process (of sampling and generating a set of feature importance values) repeats with the same sample size, but a different portion of input dataset 120. At every iteration thereafter, the sample size doubles from the previous sample size. This exponential growth in sample size is used to enable fair comparison of two sets of feature importance values associated with two consecutive iterations, since both sets of feature importance values would be based on samples of equal size. Thus, iterative component 150 is considered an “adaptive sampler” because it implements an adaptive sampling technique.

While one approach to approximating a global explanation of ML model 110 involves selecting an arbitrary sample size from input dataset 120, a significant challenge is to find that sample size so that the global explanation is precise enough with the minimum number of local explanations (i.e., sets of feature importance values for subsets of input dataset 120) computed to ensure timely completion. Therefore, the sample size should adapt depending on the dataset.

Iterative component 150 implements a stopping condition (or set of stopping conditions) after every iteration, or after every generation of a set of feature importance values after the second set is generated. This stopping condition is implemented without knowing how far the latest set of feature importance values is to the “baseline” (which is the set of feature importance values that is based on the entire input dataset 120) by checking for convergence. A metric used to measure convergence may be subtracting the latest set of feature importance values with a set of feature importance values that is based on the previous set of feature importance values, resulting in an error vector.

A norm of the error vector is then computed. A vector's norm is also referred to as the magnitude of the vector or the length of the vector. The norm of a vector is the square root of the sum of each component (or value) squared. For example, a simple vector is {2, 5, 4} and its norm is the square root of the sum of 4, 25, and 16, which is the square root of 45.

That norm may then be standardized by being dividing by the norm of the previous set of feature importance values. The result of this division is then compared to a threshold value to confirm whether iterative component 150 should terminate. If so, then the latest set of feature importance values is used as the global explanation of ML model 110.

The threshold value may be defined depending on needs, such as requiring high accuracy or requiring low computation time. The higher the threshold value (e.g., greater than 0.1), the lesser the computation time, but also the lower the accuracy. The lower the threshold value (e.g., less than 0.1), the higher the accuracy, but also the greater the computation time.

Although depicted separately, feature importance generator 130 and iterative component 150 may be implemented in a single program, or functions of each may be implemented in two or more programs that communicate with each other. For example, iterative component 150 may be triggered based on user input that identifies a ML model, causing iterative component 150 to invoke sampler 152 to sample data from input dataset 120, which passes the sample to feature importance generator 130, which sends output to iterative component 150, which passes the output along with other data to comparator 154. Iterative component 150 then analyzes output from comparator 154 to determine whether to sample additional data from input dataset 120. As another example, these functional components of system 100 may be implemented in a single program; thus, no cross-program communication is required.

### Process Overview

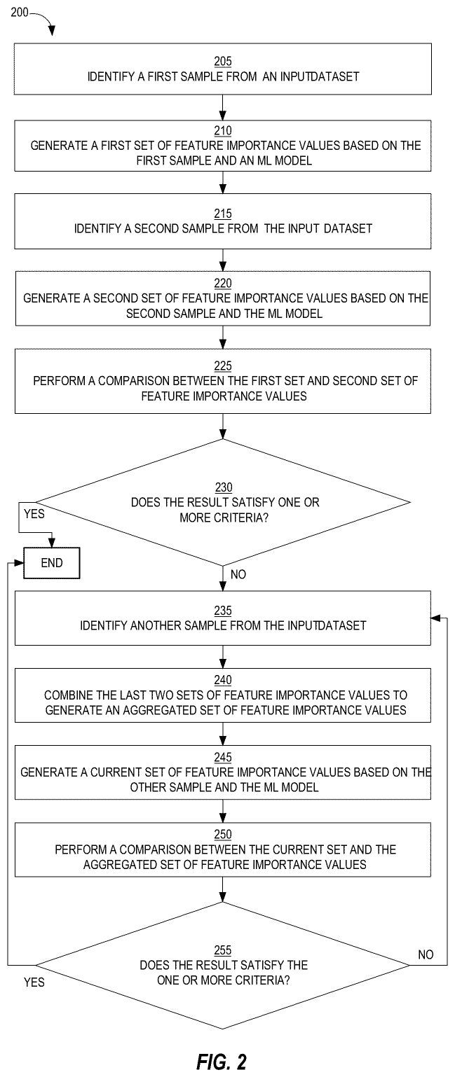

FIG. 2 is a flow diagram that depicts an example process 200 for performing adaptive sampling, in an embodiment. Process 200 may be performed by different components of system 100. Alternatively, process 200 may be performed by a computer system that is configured differently than system 100.

At block 205, a first sample from an input dataset is identified. Block 205 may be performed by iterative component 150 invoking sampler 152. The size of the sample may be a default value that is defined in a configuration file accessible to iterative component 150 or may be hardcoded in the application code of iterative component 150. The first sample may be the first set of data in the input dataset. For example, if the input dataset is 10 million rows, then the first sample may be the first 1000 rows of the input dataset. Alternatively, the first sample may be a random set of data from the input dataset.

The size of the first sample may be a default value and may be configurable. In a related embodiment, the size of the first sample may vary depending on the size of the input dataset. For example, the larger the input dataset, the larger the size of the first sample.

At block 210, a first set of feature importance values is generated based on the first sample and the ML model. The set of feature importance values may be Shapley values. Block 210 may involve iterative component 150 invoking feature importance generator 130 and passing a reference to the first sample that is stored in memory, such as a certain location in RAM or in non-volatile storage, such as disk or Flash memory. Block 210 may also involve storing the set of feature importance values as a vector in output values 140.

At block 215, a second sample from the input dataset is identified. Thus, block 215 is similar to block 205, except that another portion of the input dataset is read.

At block 220, a second set of feature importance values is generated based on the second sample and the ML model. Block 220 is similar to block 210, except that a different portion of the input dataset is used.

At block 225, a comparison between second set of feature importance values and the first set of feature importance values is performed. Block 225 may involve retrieving each set of feature importance values from output values 140 and performing a difference between the two sets, resulting in a difference set, where each value in the difference set is based on differencing the corresponding values in the two sets. (Again, each set may be a vector and the result of differencing may be referred to as a difference vector.) A norm of the difference vector may be calculated and then divided by the norm of the first vector or first set of feature importance values. The result of the division is a single value.

At block 230, it is determined whether the result of the comparison satisfies one or more criteria. The one or more criteria may be the result being less than a threshold value. If the result satisfies the one or more criteria, then process 200 terminates. Otherwise, process 200 proceeds to block 235.

At block 235, another sample from the input dataset is identified. If this is the first iteration of block 235, then the identified sample is the third sample. In order to keep track of the portion of the input dataset that has already been sampled, an index into the input dataset may be maintained that indicates where to begin sampling the next time the input dataset is sampled. Thus, after the second sample is identified in block 215, the index may be updated then to be immediately after the second sample. And then, as part of block 235, the index may be updated to be immediately after the sample identified in this block.

Block 235 is similar to block 200, except that another portion of the input dataset is read. Also, the sample identified in block 235 is double the size of the previous sample that was retrieved from the input dataset. Thus, if the previous sample size was 1 KB, then the size of this identified sample is 2 KB.

At block 240, the last two sets of feature importance values are combined to generate an aggregated set of feature importance values. If this is the first iteration of block 240, then the last two sets of feature importance values are the first and second sets of feature importance values. The aggregated set of feature importance values becomes a “previous” set of feature importance values (i.e., one of “the last two sets of feature importance values” for a subsequent iteration of block 240 if block 240 is performed again pertaining to the same ML model).

As an example of combining two sets of feature importance values, the first value in each of the last two sets of feature importance values (which first values correspond to the same feature in the ML model) are averaged to generate a first average value that becomes the first value in the aggregated set of feature importance values, the second value in each of the last two sets of feature importance values (which second values correspond to the same feature in the ML model) are averaged to generate a second average value that becomes the second value in the aggregated set of feature importance values, and so forth.

At block 245, a current set of feature importance values is generated based on the sample identified in block 235 and the ML model. Block 245 is similar to block 210, except that a different portion of the input dataset (i.e., the sample identified in block 235) is used. If this is the first iteration of block 245, then this current set of feature importance values is the third set of feature importance values. In a related embodiment, the current set of feature importance values is an aggregation of all sets of feature importance values generated thus far.

At block 250, a comparison is performed between the current set of feature importance values and the previous set of feature importance values. Block 250 may involve storing each set of feature importance values as a vector and performing a difference between the vectors. The difference may then be divided by the previous set of feature importance values. Thus, the comparison of block 250 may be similar to the comparison of block 225. In other words, the set of operations to perform the comparison in block 250 may be the same set of operations to perform the comparison in block 225.

At block 255, it is determined whether the result of the comparison (of block 250) satisfies the one or more criteria. Therefore, block 255 is similar to block 230. If the result satisfies the one or more criteria (e.g., the result is less than the threshold value), then process 200 terminates. Otherwise, process 200 returns to block 235, where another sample is retrieved, but where the sample size doubles from the sample size of the previous sample.

### Additional Embodiments

In an embodiment, there is a limit to the number of iterations of block 235. For example, a default iteration number may be ten, meaning that block 235 may be performed ten times, but process 200 ends before block 235 is performed an eleventh time. As another example, if the sample size in an iteration of block 235 is greater than half of the input dataset, then process 200 terminates even if the threshold check in block 255 is not satisfied. Both examples indicate that it is unlikely (or impossible) for process 200 to reach convergence.

In an embodiment, prior to performing process 200, a size of input dataset 120 is determined. If the size is less than a particular size threshold, then process 200 is skipped so that an adaptive sampling technique is not performed. Thus, for input datasets that are greater than the particular size threshold, process 200 is performed. Process 200 provides a small amount of overhead compared to the scenario when the entirety of input dataset 120 is used. In other words, an adaptive sampling technique as in process 200 may perform slightly worse (in terms of CPU and time) than a non-adaptive sampling technique where both techniques involve considering the same amount of data from input dataset 120.

In an embodiment, prior to performing process 200, a number of features of ML model 110 is considered. If the number of features is less than a particular threshold number (e.g., ten), then process 200 is skipped so that an adaptive sampling technique is not performed. A reason for this embodiment is that ML model 110 is relatively small in terms of feature count and, therefore, computing as accurate feature importance scores as possible is not too costly in terms of CPU and time.

In some scenarios, it may be possible to have sub-par quality due to samples getting stuck in local minima while growing exponentially. Therefore, quality of feature importance values may suffer. To deal with this problem, in an embodiment, process 200 includes an additional step of identifying an extra sample and generating another set of feature importance values to ensure that the set of feature importance values is indeed not changing significantly. Also, in this embodiment, the threshold value can be reduced on this next iteration (involving the extra sample) to a lower value, such as from 0.1 to 0.08.

### Performance of Adaptive Sampling

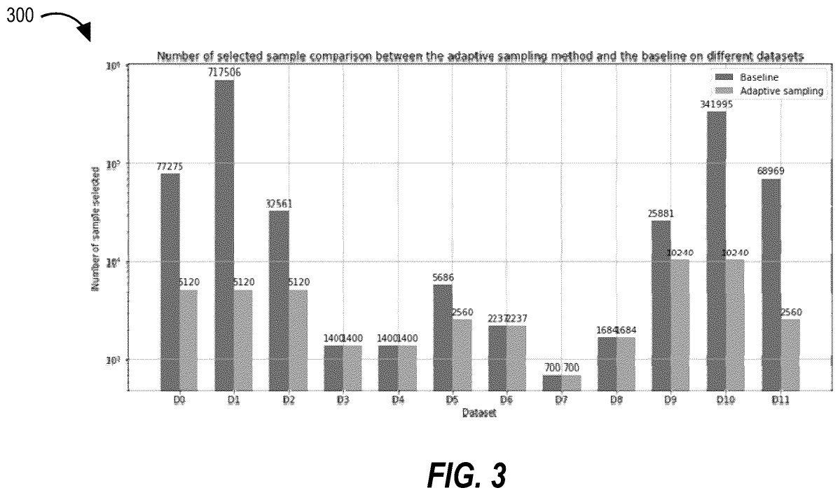

FIG. 3 is a chart 300 that depicts a measure of performance of an adaptive sampling technique relative to a non-adaptive sampling technique, in an embodiment. Chart 300 includes data about twelve different input datasets. Each dataset is associated with a pair of vertical bars. The left bar in each pair represents generating a set of feature importance values using an entire corresponding input dataset. The right bar in each pair represents generating a set of feature importance values using an adaptive sampling technique (e.g., process 200), as described herein. In each of the experiments (one for each input dataset), an error threshold of 1% is set (e.g., 0.01). The chart indicates that the larger the input dataset, the more efficient adaptive sampling is. For example, the adaptive sampling technique on input dataset D1 selects only 0.7% of the whole dataset for an iterative error of 1%. However, for relatively small input datasets, 100% of the input dataset is eventually selected as it is difficult to find a smaller subset which correctly represents the input dataset. This situation is not a problem, however, because the computation of feature importance values on every line does not take a significant amount of time and each iteration only computes values of newly selected rows and does not re-compute the previously computed rows.

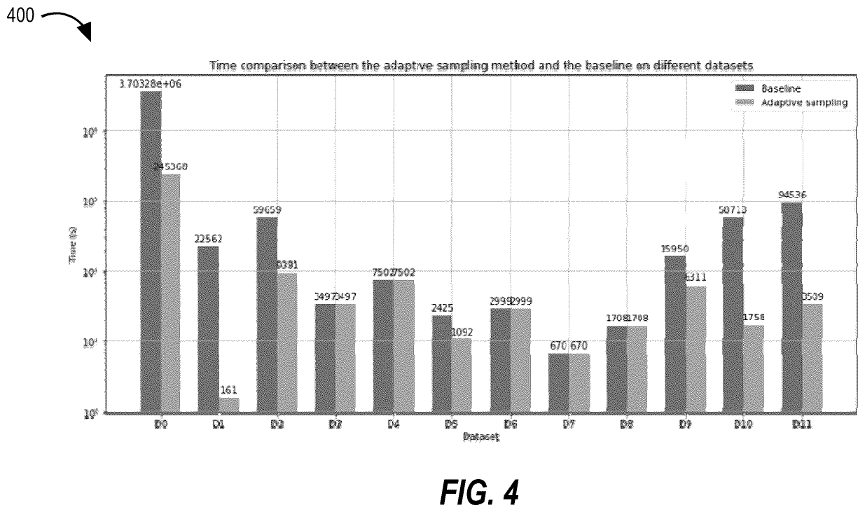

FIG. 4 is a chart 400 that depicts a different measure of performance of an adaptive sampling technique relative to a non-sampling technique, in an embodiment. Like chart 300, chart 400 includes data about twelve different input datasets and each dataset is associated with a pair of vertical bars. Specifically, chart 400 indicates computation time between the two different methods on the same input datasets. FIGS. 3 and 4 are highly correlated as the time spent on computation is linearly dependent on the number of selected samples. One aspect that changes on the different datasets is the ML model. Therefore, the time for computing a set of feature importance scores is different among the different input datasets. In cases where the adaptive sampling technique selects the entire input dataset, the overall processing time is roughly the same for both sampling techniques. This sameness reflects the fact that feature importance value generations are not repeated for the same set of rows from an input dataset, even though the adaptive sampling is iterative.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

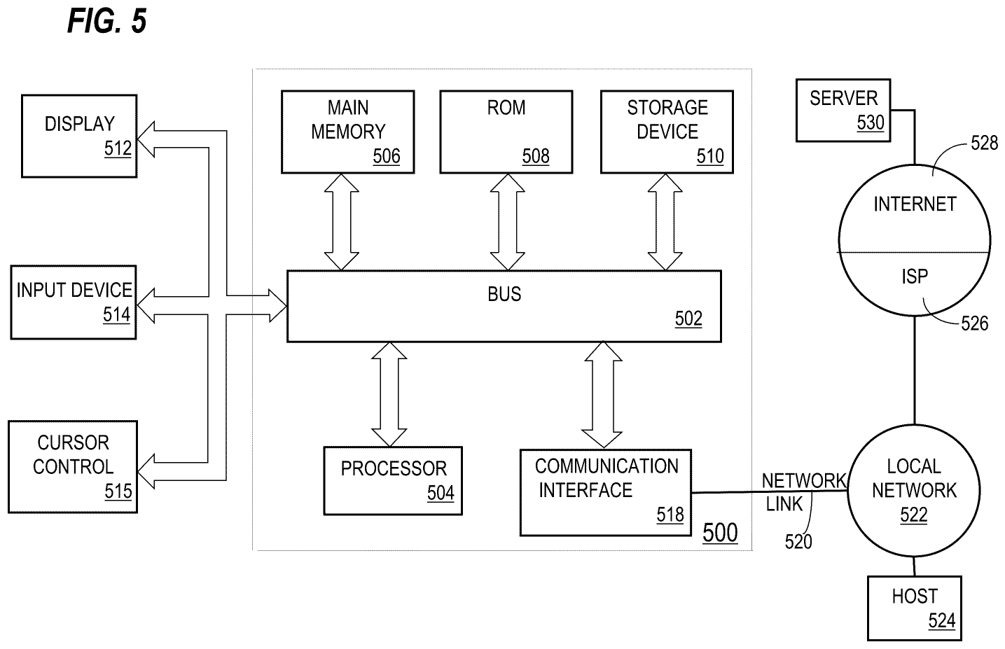

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

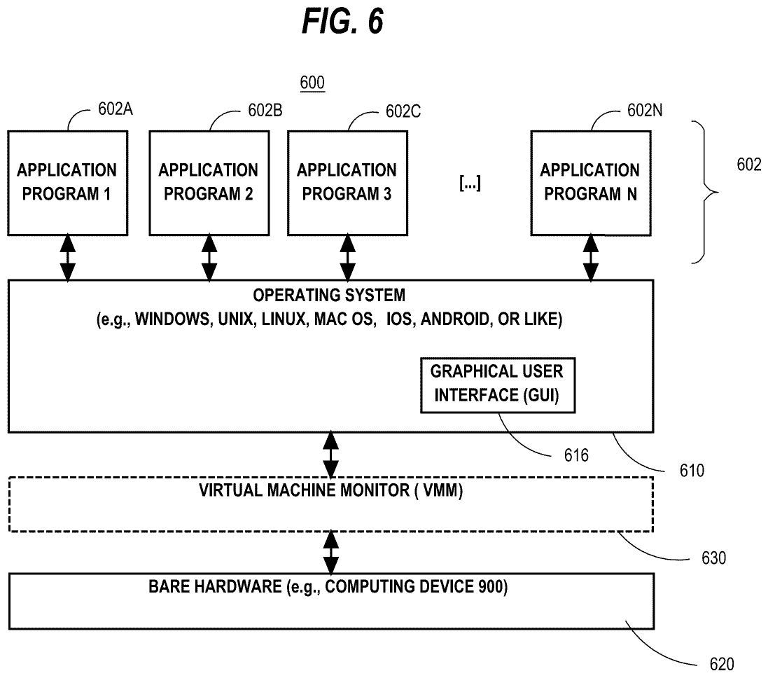

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying, from an input dataset, a first sample and a second sample;
generating a first set of feature importance values based on the first sample and a machine-learned (ML) model;
generating a second set of feature importance values based on the second sample and the ML model;
performing a first comparison between the first set of feature importance values and the second set of feature importance values;
determining whether a result of the first comparison satisfies particular criteria;
in response to determining that the result does not satisfy the particular criteria:
(i) generating an aggregated set of feature importance values based on the last two generated sets of feature importance values;
(ii) identifying, from the input dataset, a current sample that is double the size of a previous sample;
(iii) generating a current set of feature importance values based on the current sample and the ML model;
(iv) performing a second comparison between the current set of feature importance values and the aggregated set of feature importance values;
(v) determining whether a result of the second comparison satisfies one or more criteria;
repeating (i)-(v) until the result of the second comparison satisfies the one or more criteria;
wherein the method is performed by one or more computing devices.

2. The method of claim 1, wherein the one or more criteria is the result of the second comparison being less than a particular threshold value.

3. The method of claim 1, wherein the first sample and the second sample are the same size and do not overlap.

4. The method of claim 1, further comprising:
storing the first set of feature importance values as a first vector;
storing the second set of feature importance values as a second vector;
wherein performing the first comparison comprises:
subtracting the second vector from the first vector to generate a difference vector;
computing a norm of the difference vector;
dividing the norm of the difference vector by a norm of the second vector or the first vector.

5. The method of claim 1, wherein generating the aggregated set of feature importance values comprises, for each pair of corresponding values in the last two generated sets of feature importance values, computing an average of said each pair of corresponding values and storing the average in the aggregated set of feature importance values.

6. The method of claim 1, wherein:
generating the first and second sets of feature importance values comprises using a Shapley value generation technique;
the first and second sets of feature importance values are Shapley values.

7. The method of claim 1, further comprising:
determining a number of features in the ML model;
identifying the first sample and the second sample only in response to determining that the number of features is greater than a particular threshold number.

8. The method of claim 1, further comprising:
after repeating (i)-(v) a plurality of times and determining that the result of the second comparison satisfies the one or more criteria, repeating (i)-(v) one more time.

9. The method of claim 1, wherein the first comparison and the second comparison involve the same set of operations.

10. One or more non-transitory storage media storing instructions which, when executed by one or more computing devices, cause:
identifying, from an input dataset, a first sample and a second sample;
generating a first set of feature importance values based on the first sample and a machine-learned (ML) model;
generating a second set of feature importance values based on the second sample and the ML model;
performing a first comparison between the first set of feature importance values and the second set of feature importance values;
determining whether a result of the first comparison satisfies particular criteria;
in response to determining that the result does not satisfy the particular criteria:
(i) generating an aggregated set of feature importance values based on the last two generated sets of feature importance values;
(ii) identifying, from the input dataset, a current sample that is double the size of a previous sample;
(iii) generating a current set of feature importance values based on the current sample and the ML model;
(iv) performing a second comparison between the current set of feature importance values and the aggregated set of feature importance values;
(v) determining whether a result of the second comparison satisfies one or more criteria;
repeating (i)-(v) until the result of the second comparison satisfies the one or more criteria.

11. The one or more storage media of claim 10, wherein the one or more criteria is the result of the second comparison being less than a particular threshold value.

12. The one or more storage media of claim 10, wherein the first sample and the second sample are the same size and do not overlap.

13. The one or more storage media of claim 10, further comprising:
storing the first set of feature importance values as a first vector;
storing the second set of feature importance values as a second vector;
wherein performing the first comparison comprises:
subtracting the second vector from the first vector to generate a difference vector;
computing a norm of the difference vector;
dividing the norm of the difference vector by a norm of the second vector or the first vector.

14. The one or more storage media of claim 10, wherein generating the aggregated set of feature importance values comprises, for each pair of corresponding values in the last two generated sets of feature importance values, computing an average of said each pair of corresponding values and storing the average in the aggregated set of feature importance values.

15. The one or more storage media of claim 10, wherein:
generating the first and second sets of feature importance values comprises using a Shapley value generation technique;
the first and second sets of feature importance values are Shapley values.

16. The one or more storage media of claim 10, further comprising:
determining a number of features in the ML model;
identifying the first sample and the second sample only in response to determining that the number of features is greater than a particular threshold number.

17. The one or more storage media of claim 10, further comprising:
after repeating (i)-(v) a plurality of times and determining that the result of the second comparison satisfies the one or more criteria, repeating (i)-(v) one more time.

18. The one or more storage media of claim 10, wherein the first comparison and the second comparison involve the same set of operations.
